(19) United States
(12) Patent Application Publication
(10) Pub. No.: US 2008/0163280 A1
(43) Pub. Date: Jul. 3, 2008

(54) OPTICAL DISC APPARATUS

(75) Inventor: Naoki Eguchi, Yokohama-shi (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/960,266

(22) Filed: Dec. 19, 2007

(30) Foreign Application Priority Data
Dec. 27, 2006 (JP) 2006-353297

(51) Int. Cl. G11B 17/028

(52) U.S. Cl. 720/706

(57) ABSTRACT

According to one embodiment, an optical disc apparatus includes a clamping ring having a diameter a little larger than the outer diameter of the disc motor is arranged in the dead space that is provided near the motor. A clamping mechanism that can reliably chuck (clamp) an optical disc is therefore provided. That is, the cam slider for controlling the loading and ejecting of the optical disc cooperate with the clamp lever and clamping ring, both moving in the cam groove made in the cam slider. The cam slider, clamp lever and clamping ring therefore rotate the disc motor around the shaft thereof, thereby reliably moving the disc motor to the standby position.

### CROSS-REFERENCE TO RELATED APPLICATIONS

This application is based upon and claims the benefit of priority from Japanese Patent Application No. 2006-353297, filed Dec. 27, 2006, the entire contents of which are incorporated herein by reference.

### BACKGROUND

1. Field

One embodiment of the present invention relates to an optical disc apparatus that can read data from a disc recording medium, such as an optical disc, and can write data to the optical disc.

2. Description of the Related Art

Optical disc apparatuses (optical disc drives) have long been in practical use, each configured to apply a laser beam to an optical disc, thereby reproducing data from the optical disc and recording data on the optical disc.

The optical disc drive includes an optical pickup (optical head) device, a loading mechanism, a disc motor, and a control circuit. The optical pickup is moved radially across the data-recording surface of an optical disc. While being so moved, the optical pickup can read data from and write data to the optical disc. The loading mechanism is configured to load an optical disc to a prescribed position (in the optical disc drive) and to eject the disc reliably from the optical disc drive. The disc motor rotates the optical disc. The control circuit performs miscellaneous control to record data on and reproduce data from the optical disc.

Small optical discs (of diameter 8 cm) are used today as recording media in video cameras.

It is therefore demanded that the optical disc drive should read data from and write it to both a conventional 12-cm optical disc and an 8-cm optical disc.

Japanese Patent Application Publication (KOKAI) No. 2004-39198 discloses a chucking mechanism for use in optical disc drives. The chucking mechanism is designed to chuck a disc laid at a chucking position, to a turntable. In the chucking mechanism, the disc spindle unit that has the turntable at the chucking position can be moved to and from the disc, and an upper case is provided facing the disc across the chucking position. The disc spindle unit is moved toward the disc and then pushes the disc onto the upper case, generating a reaction. The reaction chucks the disc to the turntable.

Japanese Patent Application Publication (KOKAI) No. 2004-39193 discloses a disc releasing mechanism for use in optical disc drives. The disc releasing mechanism is designed to release a disc from the turntable of a disc spindle unit. In the disc releasing mechanism, the disc spindle unit can be moved in the axial direction with respect to a disc cover. When the disc spindle unit is moved in a direction to release the disc, the disc is set in engagement with the disc cover. As a result, the disc is released from the turntable, while remaining on the disc cover.

Japanese Patent Application Publication (KOKAI) No. 6-243654 discloses a disc cartridge drive that has a disc cartridge that is arranged at a prescribed position and a spindle motor that can be moved up and down. In the disc cartridge drive, each disc-cartridge loading position is set on the upper surface of the upper half of the disc cartridge as the spindle motor is moved up and down.

The chucking mechanism and the disc releasing mechanism disclosed in Japanese Patent Application Publications. 2004-39198 and 2004-39193, respectively, have a mechanism for moving a motor up and down. The mechanism moves the motor up, setting the motor into engagement with the projection provided on the top plate, thereby to clamp a disc. The mechanism moves the motor down, setting the motor into engagement with the projection provided on the bottom plate, thereby to release the disc. The mechanism has two cam sliders, one extending at right angles to the other. The cam sliders are coupled and driven together. Inevitably, the disc transporting mechanism and the disc positioning mechanism are not only complex, but also will increase the manufacturing cost of the optical disc apparatus that incorporates the chucking mechanism or the disc releasing mechanism.

This means that any portable apparatus incorporating the optical disc drive, such as a personal computer, has its weight unavoidably increased.

The disc cartridge drive disclosed in Japanese Patent Application Publication 6-243654 can indeed set each disc-cartridge loading position on the upper surface of the upper half of the disc cartridge, as the spindle motor is moved up and down. However, the disc cartridge drive is complex in mechanical structure.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram showing an example of an optical disc apparatus (optical disc drive) according to an embodiment of the invention;

FIG. 2 is a diagram showing a 12-cm optical disc being inserted into the optical disc apparatus (FIG. 1) according to the embodiment of the invention;

FIG. 3 is a diagram of the optical disc apparatus shown in FIG. 2, depicting some components that rotate the disc motor;

FIG. 4 is a diagram of the optical disc apparatus shown in FIGS. 2 and 3, explaining how the disc motor is moved up and down as the clamp ring is rotated;

FIGS. 5A and 5B are diagrams of the optical disc apparatus shown in FIGS. 2 and 3, explaining how the disc motor is rotated to a standby position so that an optical disc may be inserted or ejected, and also explaining how an optical disc is chucked to the turntable of the disc motor;

FIG. 6 is a diagram of the optical disc apparatus shown in FIGS. 2, 3 and 4, explaining how the disc motor is rotated to release an optical disc from the turntable of the disc motor;

FIGS. 7A to 7C are diagrams of the optical disc apparatus shown in FIGS. 2 to 4, explaining how the disc motor rotates as it is moved up and down (while remaining at the normal position);

FIGS. 8A to 8C are diagrams of the optical disc apparatus shown in FIGS. 2 to 4, explaining how the disc motor rotates as it is moved up and down (while rotating);

FIGS. 9A to 9C are diagrams of the optical disc apparatus shown in FIGS. 2 to 4, explaining how the disc motor rotates as it is moved up and down (while the optical disc is being played black);

FIGS. 10A and 10B are diagrams each showing, in detail, how a 12-cm optical disc is inserted into the optical disc apparatus shown in FIG. 1;

FIGS. 11A and 11B are diagrams, each showing, in detail, how an 8-cm optical disc is inserted into the optical disc apparatus shown in FIG. 1; and

FIG. 12 is a diagram of the optical disc apparatus shown in FIG. 1, depicting an optical disc inserted in the optical disc apparatus and remaining in a rotatable state (because the loading arm and the disc holding lever stay at the standby position.)

### DETAILED DESCRIPTION

Various embodiments according to the invention will be described hereinafter with reference to the accompanying drawings. In general, according to one embodiment of the invention, an optical disc apparatus comprising: a turntable which supports an optical disc and from which the optical disc is able to be removed from; a disc motor which has a shaft coupled to the turntable and which is configured to rotate the turntable at a prescribed speed; a ring member which has a diameter larger than an outer diameter of the disc motor and which is configured to rotate the disc motor; a plurality of projections which are provided on an outer circumferential surface of the disc motor and which receive rotation from the ring member; a plurality of slider members provided on the outer circumferential surface of the disc motor and which receive rotation from the ring member; and a cam mechanism which linearly moves to rotate the ring member.

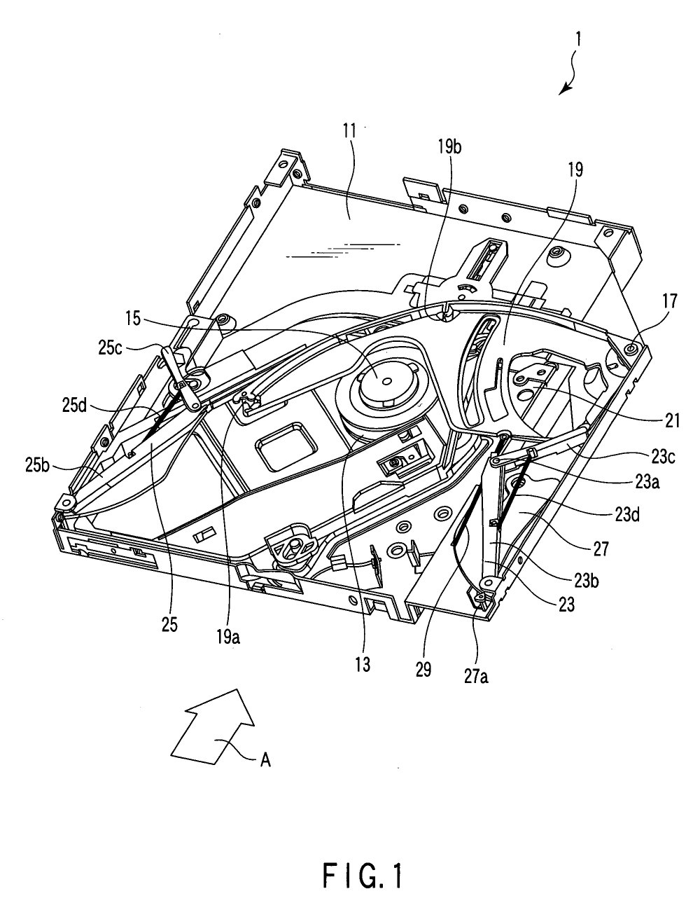

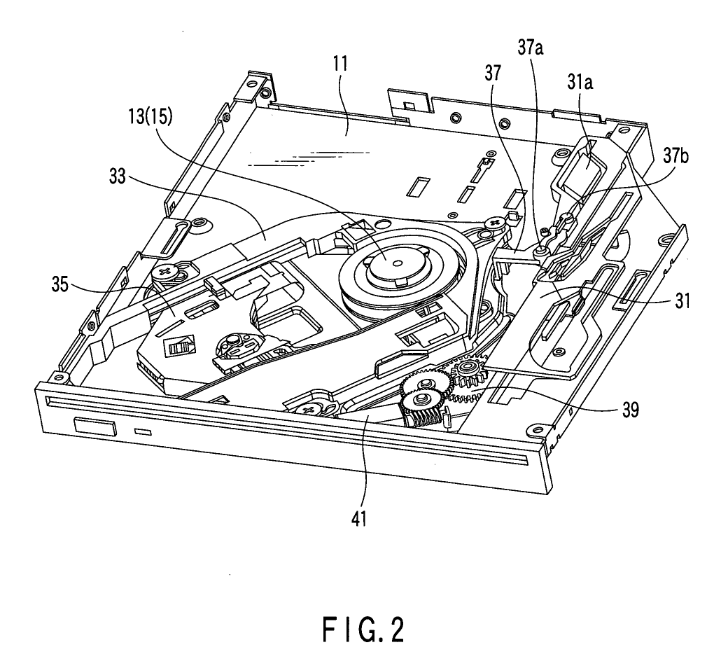

FIGS. 1 and 2 show an example of an optical disc apparatus according to an embodiment of the invention. The optical disc apparatus shown in FIGS. 1 and 2 are a so-called slot-in type, in which an optical disc is inserted so that data may be recorded in and reproduced from, the optical disc. The optical disc apparatus is designed for use in, for example, portable personal computers (notebook PCs). FIG. 1 shows the optical disc apparatus, with some covers of the housing having been removed. FIG. 2 shows the optical disc apparatus, with some components having been removed and some components added, and how an optical disc is inserted into the optical disc apparatus.

The optical disc apparatus 1 shown in FIGS. 1 and 2 has a bottom cover, i.e., chassis 11, and a disc motor 13. The disc motor 13 is mounted on the chassis 11, almost at the center of the chassis 11. A turntable 15 is secured to the shaft of the disc motor 13 (not designated by any reference number), to hold an optical disc.

In the vicinity of the turntable (disc motor 13), a loading arm 19 is provided, which can rotate around a fulcrum 17 provided at a prescribed position on the chassis 11.

The loading arm 19 has a first positioning projection 19a and a second positioning projection 19b. The first positioning projection 19a is positioned at prescribed distances from the fulcrum 17. It can contact a part of the circumference of an optical disc inserted toward the turntable 15 in the direction of arrow A. The second positioning projection 19b is positioned between the first positioning projection 19a and the fulcrum 17. The first positioning projection 19a is positioned and shaped to contact the outer circumference of an optical disc before the recording surface of the optical disc contacts the turntable 15, regardless of the diameter of the optical disc being inserted in the direction of arrow A. The second positioning projection 19b is positioned and shaped to contact the outer circumference of an optical disc when its center hole substantially aligns with the center of the turntable 15, regardless of the diameter of the optical disc being inserted in the direction of arrow A.

A first disc guide 23 and a second disc guide 25 are provided on two opposing edges of the chassis 11, respectively. (In other words, the first disc guide 23 and the second disc guide 25 are located on the right and left of the turntable 15, respectively, as viewed in the direction of arrow A.) The first disc guide 23 and the second disc guide 25 cooperate with the loading arm 19 to support an optical disc being inserted in the direction of arrow A and to guide the optical disc to the loading arm 19. The first and second disc guides 23 and 25 oppose each other across the turntable 15. Thus, the turntable 15 lies between the guides 23 and 25, as viewed in a direction parallel to the shaft of the disc motor 13 that supports the turntable 15.

In the vicinity of the first disc guide 23, a disc holding lever 27 is provided. The disc holding lever 27 has a disc holding pin 27a that cooperates with the first positioning projection 19a to hold the optical disc being inserted in the direction of arrow A. The disc holding lever 27 can rotate toward the turntable 15, around a fulcrum 27b provided at a prescribed position on the lever 27. The disc holding lever 27 and the loading arm 19 are biased toward each other by a spring member 29. (That is, the spring member 29 always exerts a force that pulls the disc holding lever 27 and the loading arm 19 toward each other and toward the circumference of the turntable 15.)

The first disc guide 23 is composed of a fulcrum 23a, a main disc guide 23b, a sub disc guide 23c and a spring member 23d. The fulcrum 23a couples the main disc guide 23b and the sub disc guide 23c. The spring member 23d exerts a force (tension) that pulls the main disc guide 23b and the sub disc guide 23c toward each other. The second disc guide 25 is composed of a fulcrum 25a, a main disc guide 25b, a sub disc guide 25c and a spring member 25d. The fulcrum 25a couples the main disc guide 25b and the sub disc guide 25c. The spring member 25d exerts a force (tension) that pulls the main disc guide 25b and the sub disc guide 25c toward each other.

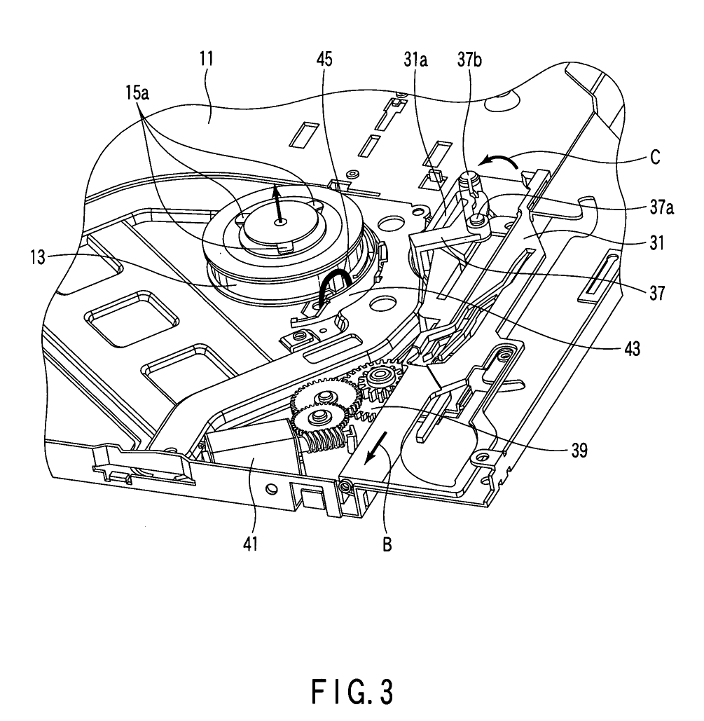

FIGS. 2 and 3 show the optical disc apparatus shown in FIG. 1, not illustrating the loading arm, first and second disc guides and disc loading lever, which have been removed.

As shown in FIGS. 2 and 3, the disc motor 13, to which the turntable 15 is secured as described above, is provided substantially at the center of the chassis 11.

Around the disc motor 13, a mechanical chassis 33 is provided on the bottom cover 11 (i.e.,) and extends away from the fulcrum 17. The mechanical chassis 33 is secured to the bottom cover 11 at, for example, three points. The mechanical chassis 33 supports a pickup head (PUH) that can move to and from the disc motor 13.

Between the mechanical chassis 33 and the fulcrum 17, a clamp lever 37 is provided. The clamp lever 37 can rotate around the shaft of the disc motor 13 by a predetermined angle as a cam slider 31 moves in parallel. The clamp lever 37 can rotate around a clamp-lever fulcrum 37a, too, by a predetermined angle along a clamp-cam groove 31a made in the cam slider 31. The clamp lever 37 has a cam-engagement projection 37b, which is set in engagement with the clamp-cam groove 31a. Hence, the clamp lever 37 is rotated by the predetermined angle as the cam slider 31 moves in parallel.

The cam slider 31 can move in parallel on the bottom cover 11 as the forward or inverse rotation of a loading motor 41 is transmitted to the cam slider 31 by a series of gears 39. Assume that the cam slider 31 moves in the direction of arrow B shown in FIG. 3. Then, the clamp lever 37 is rotated in the direction of arrow C. As the camp lever 37 is rotated, a clamp ring 43 supporting the disc motor 13 is rotated around the shaft of the disc motor 13. As a result, the disc motor 13, which is pushed onto the clamp ring 43 by a motor-pushing spring 45, is rotated by a prescribed angle around its shaft as described above.

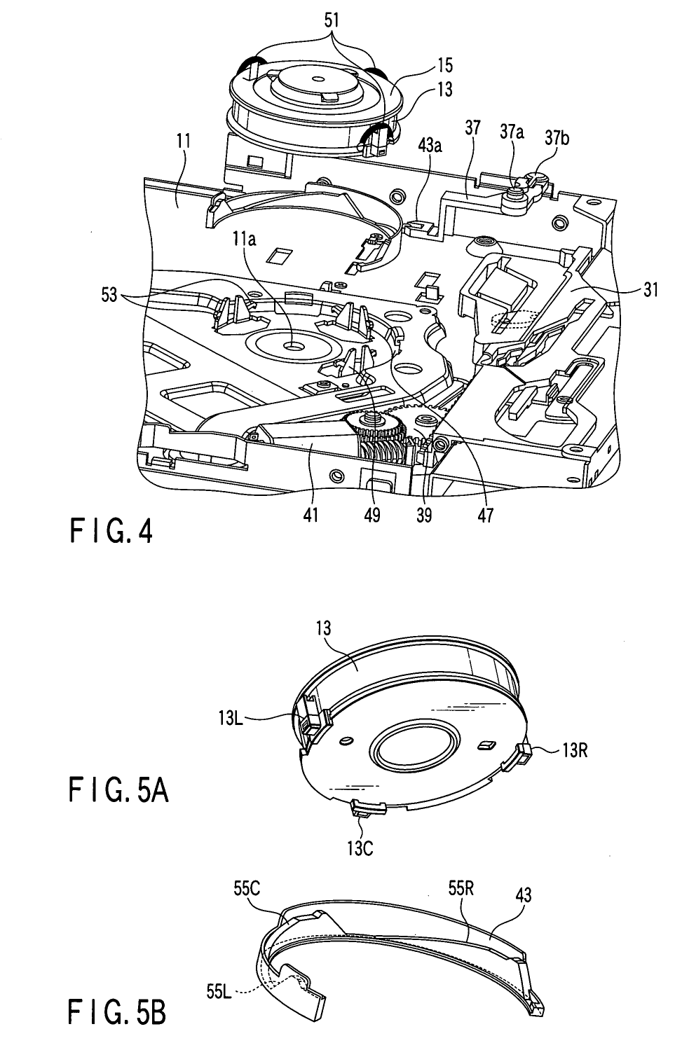

FIG. 4 shows how the disc motor is moved up and down as the clamp ring is rotated as described with reference to FIGS. 2 and 3.

As explained with reference to FIG. 1, the optical disc apparatus 1 is a slot-in type. Therefore, the apparatus 1 performs a loading operation to transport an optical disc to the housing, and an ejecting operation to eject the optical disc from the housing. In most cases, the disc motor remains off the path along which the optical disc moves, until the optical disc is guided to a prescribed position (clamping position), and similarly until the optical disc is ejected from the optical disc apparatus.

To keep the disc motor 13 off the path along which the optical disc moves, the housing (motor case) of the disc motor 13 and the chassis 11 of the optical disc apparatus 1 are appropriately designed as will be described below. The disc motor 13 as a whole is thereby rotated around its shaft. The disc motor 13 (particularly, the turntable 15) can therefore approach the chassis 11, moving away from the path along which the optical disc moves.

A ring guide wall 47 is provided substantially at the center of the chassis 11. The ring guide wall 47 is coaxial to the rotation axis 11a of the disc motor 13 (i.e., the axis of the motor shaft) set in place and has a diameter slightly larger than the outer diameter of the motor case housing the disc motor 13.

A plurality of, for example three, lift guides 49 are provided arranged between the ring guide wall 47 and the rotation axis 11a. The lift guides 49 are arranged on a circle having a diameter substantially equal to the diameter of the motor case and are spaced from one another at almost regular angular intervals of 90° or more. The lift guides 49 can restrict the position the disc motor 13 can take and can yet allow the disc motor 13 to move up and down (in a direction parallel to the shaft of the disc motor 13) as will be described below. Each lift guide 49 has a pair of hooks 53 that hold a motor-biasing spring 51. The motor-biasing springs 51 push the disc motor 13 onto the bottom cover 11 while the lift guides 49 keep hold of the disc motor 13.

Cam-abutting projections 13R, 13C and 13L (three projections in this embodiment, as sown in FIG. 5A) are provided on the outer circumferential surface of the hollow cylinder of the motor case and spaced at substantially the same angular intervals as the lift guides 49. The cam-abutting projections 13R, 13C and 13L have the same phase as the lift cams 55R, 55C and 55L (see FIG. 5B) that are arranged between the ring guide wall 47 and the case of the disc motor 13. In the process of assembling the optical disc apparatus 1, the cam-abutting projections 13R, 13C and 13L (FIG. 5A) are positioned at the lift cams 55R, 55C and 55L (FIG. 5B), respectively.

The load the motor-biasing springs 51 exert on the hooks 53 always pushes the motor case (disc motor 13) onto the lift cams 55R, 55C and 55L of the clamp ring 55. In this state, the motor case is held on the bottom cover 11. As shown in FIG. 5B, the lift cams 55R, 55C and 55L have a standby part (defining the normal position), a slider part continuous to the lowest standby part, a flat part (defining disc-playback position) continuous to the slider part, and a projecting part continuous to the flat part.

The normal position is the lowest position that the disc motor 13 has. The slider part changes in height in the circumferential direction. When the clamp ring 55 is rotated around its axis by a prescribed angle, each of the cam-abutting projections 13R, 13C and 13L moves from the standby part to projection part of the corresponding lift cam. As a result, the distance between the motor case (disc motor 13) and the bottom cover 11 is changed. The projecting part of the lift cam 55C is lower than those of the other lift cams 55R and 55L by a preset value. Therefore, the lift guides 49 (three guides) provided on the bottom cover 11 guide the cam-abutting projections 13R, 13C and 13L, respectively. This restricts the position the disc motor 13 has in the plane direction.

The motor-pushing springs 45, which are stretched over the three pairs of hooks 53 formed on the bottom cover 11, push the cam-abutting projections 13R, 13C and 13L onto the lift cams 55R, 55C and 55L. The disc motor 13 is thereby set at a specific position in the height direction. The projection parts of the lift cams 55R, 55C and 55L of the clamp ring 55 serve to lift the disc motor 13 a little higher when the optical disc is clamped (chucked) than when the optical disc is rotated to reproduce signals from it or to record signals in it. Therefore, the projection parts of the lift cams 55R, 55C and 55L are useful in raising the disc motor 13, making it easier to clamp the optical disc.

The clamp ring 43 has a ring-engagement projection 43a on the outer circumferential surface. The ring-engagement projection 43a is set in engagement with an end of the clamp lever 37 rotatably supported on the bottom cover 11. Note that the cam-engagement projection 37b is provided at the other end of the clamp lever 37. The cam-engagement projection 37b is set in the clamp-cam groove 31a made in the cam slider 31, which slides back and forth on the bottom cover 11. Thus, as the cam slider 31 slides so, the clamp lever 37 and the clamp ring 43 are rotated.

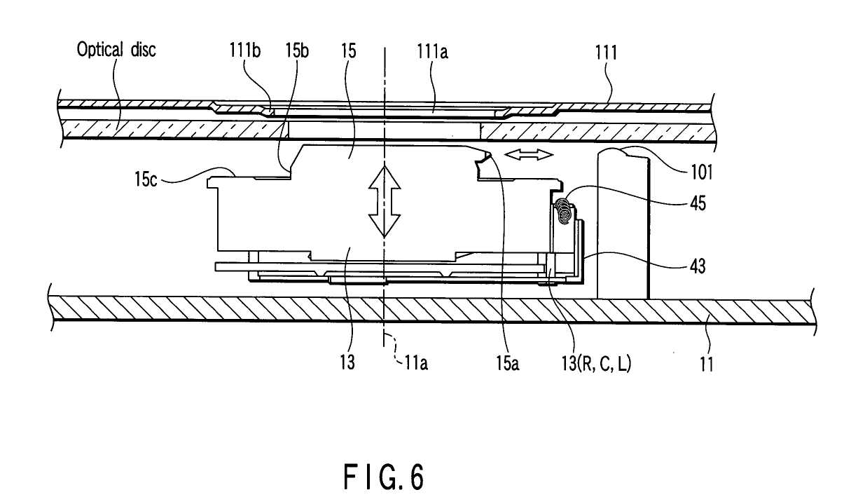

FIG. 6 explains how an optical disc is released from the turntable 15 (from the clamped or chucked state) in the optical disc apparatus.

The turntable 15, which is integrally formed with the disc motor 13, has a disc-mounting surface. The turntable 15 has ball-chucking claws 15a (three claws) for pressing an optical disc onto the disc-mounting surface (i.e., one side of the motor case of the disc motor 13). A part of the motor case serves as a clamping case 15b (housing) and a base 15c (table unit). The clamping case 15b can fit in the center hole of the optical disc loaded. The base 15c can support that part of the optical disc which surrounds the center hole thereof. The ball-chucking claws 15a exert a prescribed pressure toward the outer circumference of the optical disc and to the bottom of the disc motor 13 (i.e., bottom cover 11.) Thus, the claws 15a push the optical disc onto the bottom of the disc motor 13 (that is, onto the bottom cover 11.)

A top cover 111 has a motor-case (turntable) hole 111a and a clamping rib 111b. The motor-case hole 111a prevents the disc motor 13 from contacting the turntable 15 and the ball-chucking claws 15a when the clamp ring 43 is rotated, moving the disc motor 13 up to the chucking (clamping) position (or to the projecting parts of the lift cams 55R, 55C and 55L). The clamping rib 111b pushes the ball-chucking claws 15a to the bottom cover 11 so that the ball-chucking claws 15a may reliably hold the optical disc. Hence, the optical disc can be reliably held on the turntable 15 when the clamp ring 43 is rotated.

A disc-releasing projection 101 is provided on the bottom cover 11. The disc-releasing projection 101 releases the optical disc from the bottom cover 11 overriding the ball-chucking claws 15a when the clamp ring 43 is rotated, moving the disc motor 13 down. As a result, the optical disc can be ejected from the optical disc apparatus 1. Thus, the optical disc can be reliably released from the turntable 15 and the chucking claws 15a when the clamp ring 43 is rotated, moving the disc motor 13 down (toward the bottom cover 11.)

That is, in the present embodiment, the clamp ring 43 is rotated, moving the disc motor 13 up or down, as the as the cam slider 31 slides. When the disc motor 13 is moved up, the disc motor 13 is clamped (chucked) to the turntable 15. When the disc motor 13 is moved down, the disc motor 13 is released from the turntable 15.

More specifically, to clamp an optical disc, the disc motor is moved up. As the disc motor is up, the optical disc is moved up, too, because it interferes with the chucking claws 15a of the turntable 15 integrally formed with the motor case. At this time, the optical disc is held by the chucking claws 15a and pushed onto the disc-mounting surface of the turntable 15 secured to the shaft of the disc motor 13. As it is so pushed, the optical disc is held by the clamping rib 111b and axially aligned with the clamping case 15b (housing) of the turntable 15.)

To release the optical disc from the clamped state, the disc motor 13 is moved down. The optical disc, which is pushed onto the turntable 15 by the chucking claws 15a, is thereby moved down. At this time, the optical disc abuts on the disc-releasing projection 101 and is released from the chucking claws 15a and, thus, from the turntable 15.

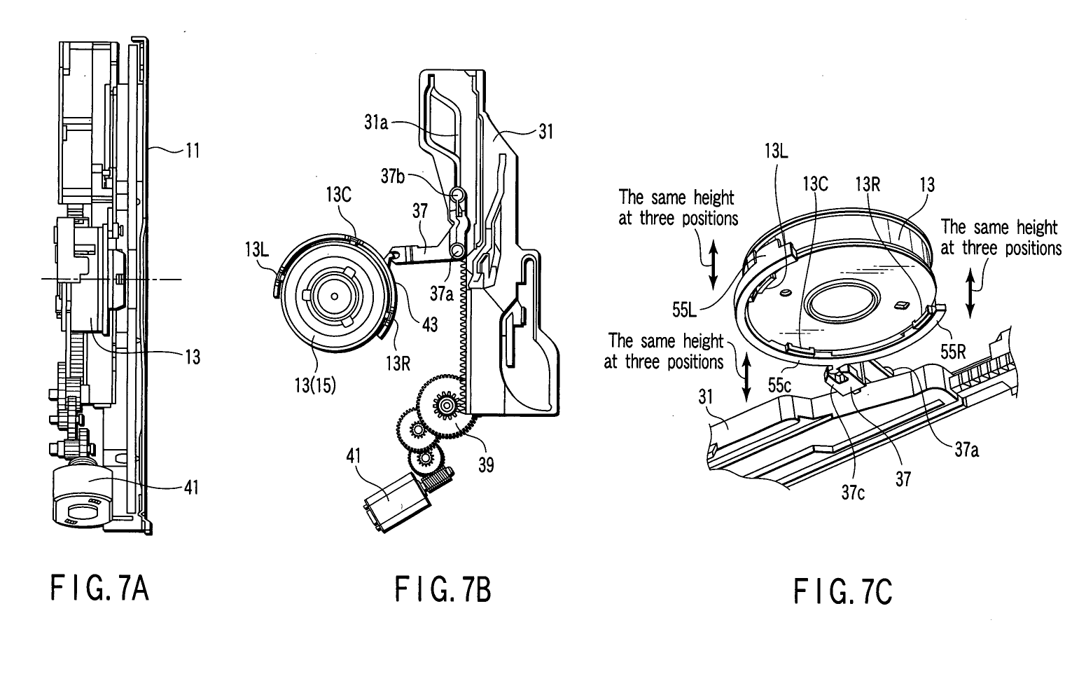

How the disc motor 13 is moved down or up as the cam slider 31 slides will be described in detail, with reference to FIGS. 7A to 7C, FIGS. 8A to 8C and FIGS. 9A to 9C. Of these figures, FIGS. 7A, 8A and 9A show the positional relation between the disc motor 13 and the chassis 11, FIGS. 7B, 8B and 9B show the relation between the parallel motion of the cam slider 31 and the rotations of the clamp ring 43 and clamp lever 37, and FIGS. 7C, 8C and 9C show the positional relation between the disc motor 13 and the lift cams 55R, 55C and 55L of the clamp ring 43.

FIGS. 7A to 7C show the disc motor 13 at the “down” position, or normal position, where the motor 13 remains closest to the bottom cover 11. As seen from FIG. 7B, the line connecting the fulcrum 37a and cam-engagement projection 37b of the clamp lever 37 is almost parallel to the lack-gear section of the calm slider 31. While the disc motor 13 remains at the “down” position, the lift cams 55R, 55C and 55L formed on the clamp ring 43 stay at the lowest position (standby position), and the cam-abutting projections 13R, 13C and 13L of the disc motor 13 stay at the lowest position, substantially close to the mechanical base chassis 11, and are held in a horizontal position.

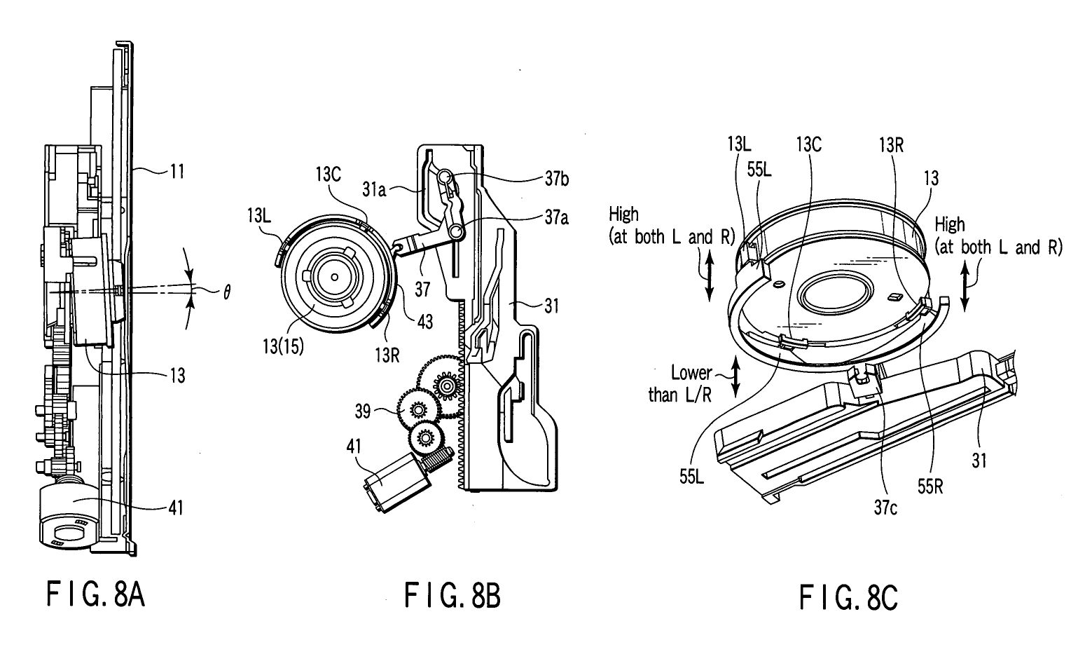

FIGS. 8A to 8C show the lift cams 55R, 55C and 55L of the clamp ring 43, which are set at a sloping part between the “down” position (standby position) and disc-playback position (planar position) of the disc motor 13, or positioned at the slider section for moving the disc motor 13 up and down. As seen from FIG. 8B, the line connecting the fulcrum 37a and cam-engagement projection 37b of the clamp lever 37 is not parallel to the lack-gear section of the calm slider 31. As seen from FIG. 8A, the disc motor 13 inclines by angle θ due to the slider section, to the perpendicular to the center hole 11a made in the bottom cover 11, or to the shaft of the disc motor 13 set at the normal position or disc-playback position. The angle θ of inclination is defined because the projection part of the lift cams 55C has a smaller height than the projection parts of the lift cams 55R and 55L.

The pushing force, which acts between the chucking claws 15a and the center hole of the optical disc to clamp (chuck) the disc or release the disc as explained with reference to FIG. 6, can therefore be more reduced than in the case where the disc motor 13 is moved in parallel only.

To clamp (chuck) the optical disc, the disc motor 13 is inclined a little (by angle θ) and then moved to the clamping position. To release the optical disc from the clamped state (i.e., chucked state), the disc motor 13 is inclined a little (by angle θ) and then moved from the clamping position. Hence, a small load suffices to clamp (chuck) the optical disc and to release the optical disc from the clamped (chucked) state.

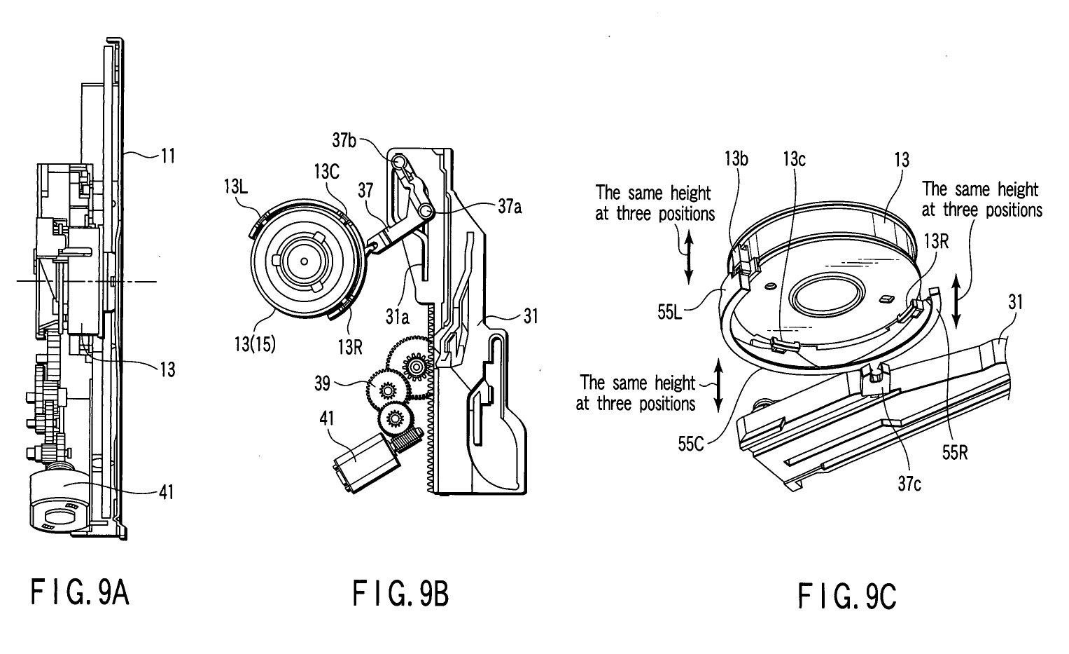

FIGS. 9A, 9B and 9C show the disc motor 13 in a completely clamped state. More precisely, they show the cam-abutting projections 13R, 13C and 13L of the disc motor 13, which are set at a planar position (disc-playback position), or at the same height as the lift cams 55R, 55C and 55L of the clamp ring 43. As seen from FIG. 9B, the line connecting the fulcrum 37a and cam-engagement projection 37b of the clamp lever 37 and the lack-gear section of the calm slider 31 defines the largest angle. (The clamp-cam groove 31a made in the cam slider 31 inclines at the largest angle to the lack-gear section.) At this time, the cam-abutting projections 13R, 13C and 13L of the disc motor 13 are pressed on the lift cams 55R, 55C and 55L of the clamp ring 43, respectively, and are therefore held in a horizontal position.

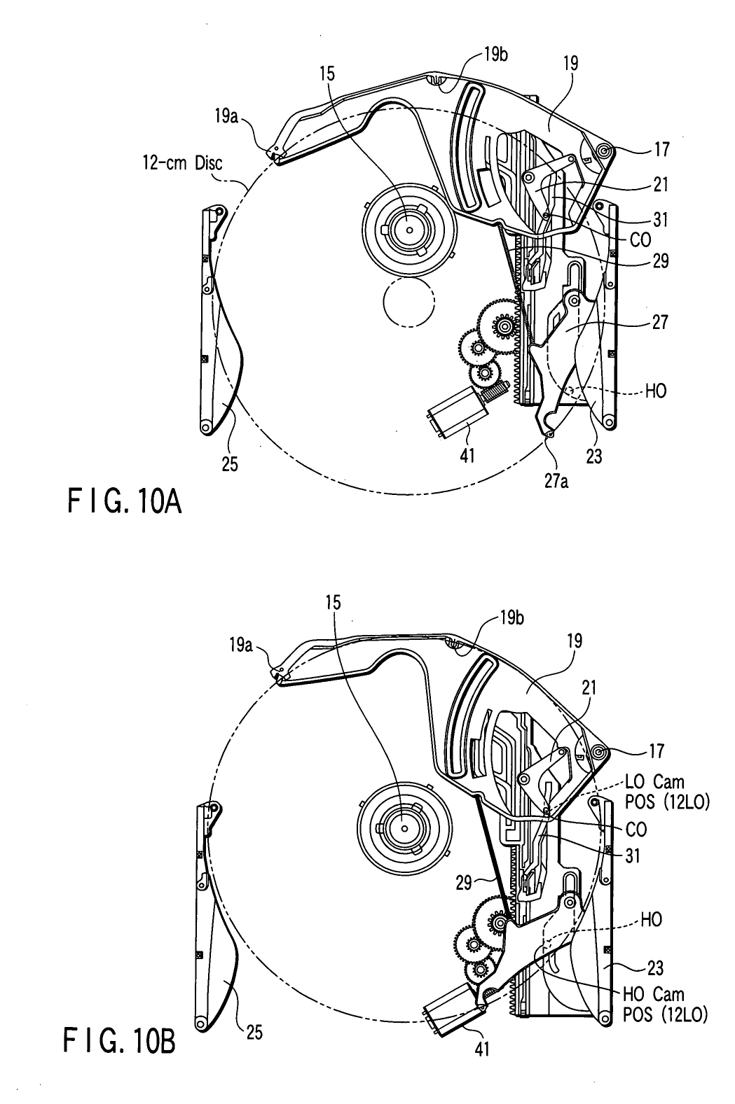

Since the cam slider 32 moves in parallel as shown in FIG. 7B, FIG. 8B and FIG. 9B, a 12-cm disc and an 8-cm disc can be easily loaded and positioned in the optical disc apparatus 1, as will be explained later with reference to FIGS. 10A and 10B, FIGS. 11A and 11B and FIG. 12.

FIGS. 10A and 10B depict the mechanical base chassis 11 as viewed from above and from below.

How a 12-cm disc and an 8-cm disc are loaded and positioned in the optical disc apparatus 1 as the cam slider 31 moves in parallel as shown in FIGS. 7B, 8B and 9B will be explained below, with reference to FIGS. 10A and 10B and FIGS. 11A and 11B and FIG. 12.

As shown in FIG. 10A, an optical disc (12-cm disc) is inserted (or pushed) into the optical disc apparatus 1 in the direction of arrow A. The outer circumference of the optical disc eventually contacts, at a given point, the disc holding pin 27a of the disc holding lever 27. The optical disc is then guided toward the loading arm 19 (and toward the turntable 15) and contacts the first positioning projection 19a of the loading arm 19. As described above, the disc holding lever 27 and the loading arm 19 are exerted with a predetermined tension and pulled toward the turntable 15. The optical disc is therefore guided to the turntable 15, while being supported by the disc holding lever 27 and the loading arm 19.

As the optical disc is further pushed in this state, the loading arm 19 rotates around the fulcrum 17, moving away from the turntable 15.

As the optical disc is inserted still further into the optical disc apparatus 1 (or as the loading arm 19 is rotated), the fulcrum 23a of the first disc guide 23 and the fulcrum 25a of the second disc guide 25 are gradually moved outwards, preventing the optical disc from moving in any undesirable manner.

As the optical disc is pushed deeper into the apparatus 1, the fulcrums 23a and 25a of the first and second disc guides 23 and 25, respectively, are moved to their outermost positions. As a result, the main disc guide 23b and sub disc guide 23c of the first disc guide 23 extend in a substantially straight line, and the main disc guide 25b and sub disc guide 25c of the second disc guide 25 extend in a substantially straight line as shown in FIG. 8A. Then, the disc holding lever 27 and the loading arm 19 transports the optical disc until the center of the optical disc reaches the turntable 15.

As the disc holding lever 27 and the loading arm 19 are rotated, the optical disc held by the disc holding lever 27 and the loading arm 19 is further transported until its center aligns with the center of the turntable 15 as shown in FIG. 10B. At this point, the first and second positioning projections 19a and 19b of the loading arm 19 cooperate, reliably aligning the center of the optical disc with the center of the turntable 15.

More precisely, as the 12-cm disc is inserted into the optical disc apparatus 1, the first and second disc guide 23 and 25 are moved outwards. When the optical disc reaches a sufficiently deep position (FIG. 10B), a cam slider 31 is driven by a loading motor (not shown), further transporting the optical disc held between the first and second positioning projections 19a and 19b of the loading arm 19 and the disc holding pin 27a of the disc holding lever 27.

As the cam slider 31 further slides, the engagement projection CO of a connection lever 21 enters an LO cam POS (12LO). Then, the first and second positioning projections 19a and 19b of the loading arm 19 are moved, guiding the optical disc until the center of the disc aligns with the center of the turntable 15 (or the shaft of the disc motor 13). At the same time, the engagement projection HO of the disc holding lever 27 enters an HO cam POS (12LO). Then, the disc holding pin 27a moves, pushing the optical disc until the center of the disc aligns with the center of the turntable 15 (or the shaft of the disc motor 13). The optical disc is thereby set at a prescribed position on the turntable 15, where it should be clamped.

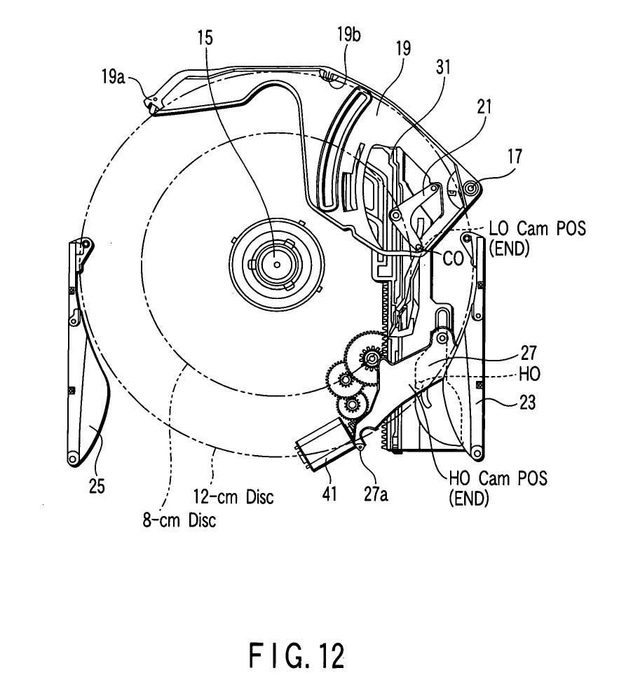

As the optical disc is inserted into the optical disc apparatus 1 as described with reference to FIGS. 7A and 7B, FIGS. 8A and 8B and FIGS. 9A to 9C, the turntable 15 (disc motor 13) is moved upwards from the standby position near the mechanical base chassis 11. The optical disc is thereby clamped on the turntable 15. As a result, the optical disc is set in the optical disc apparatus 1 and can be rotated, as shown in FIG. 12.

In order to rotate the optical disc, a spring-force releasing mechanism (not shown) releases the disc holding lever 27 and the loading arm 19 from the tension that biases them toward the turntable 15 as shown in FIG. 12. Thus, the disc holding lever 27 and the loading arm 19 are inhibited from contacting the outer circumference of the optical disc.

In order to eject the optical disc, the loading arm 19 is rotated in the opposite direction (to move the optical disc to the disc-ejecting position). The optical disc can therefore be ejected with ease.

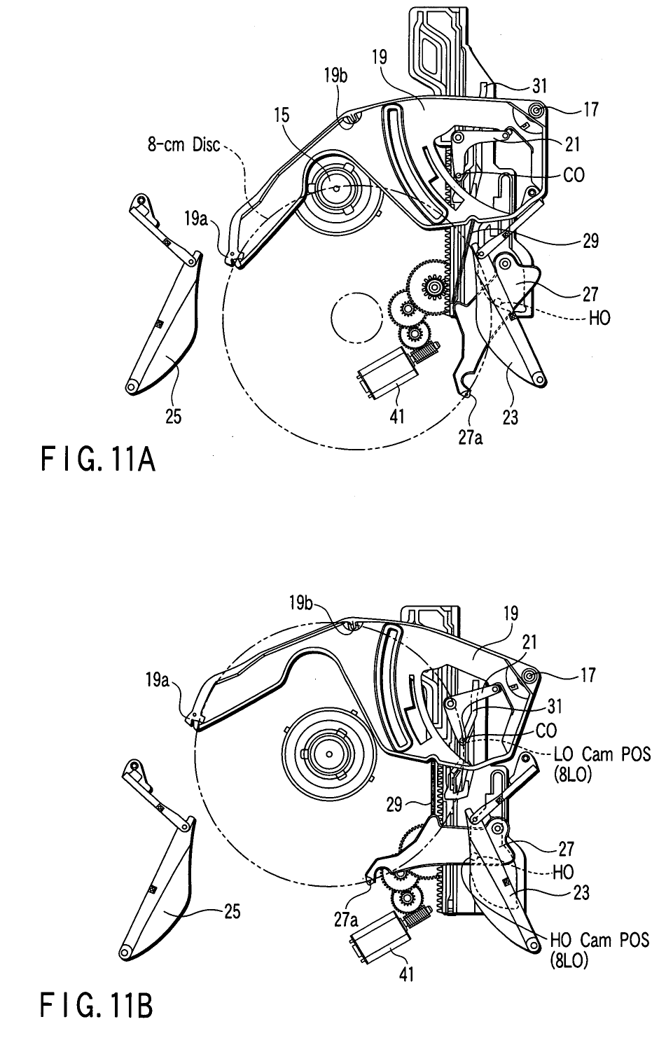

An 8-cm optical disc may be inserted (or pushed) into the optical disc apparatus 1 in the direction of arrow A. In this case, the outer circumference of the optical disc eventually contacts the disc holding pin 27a of the disc holding lever 27 as shown in FIG. 11A. The optical disc is then guided toward the loading arm 19 (and toward the turntable 15) and contacts the first positioning projection 19a of the loading arm 19. As described above, the disc holding lever 27 and the loading arm 19 are exerted with a predetermined tension and pulled toward the turntable 15. The optical disc is therefore guided to the turntable 15, while being held by the disc holding lever 27 and the loading arm 19.

As the optical disc is further pushed in this state, the loading arm 19 rotates around the fulcrum 17, moving away from the turntable 15.

At this time, the fulcrums 23a and 25b of the first and second disc guides 23 and 25, respectively, prevent the optical disc from moving in any undesirable manner. They can position the optical disc at substantially the center of the optical disc apparatus 1, almost at their initial positions or virtually without rotating (see FIGS. 11A and 11B), unlike in the case where a 12-cm disc is inserted into the optical disc apparatus 1. FIG. 11A shows the optical disc immediately before its center aligns with the center of the turntable 15.

As the disc holding lever 27 and the loading arm 19 are further rotated, the optical disc held by the disc holding lever 27 and the loading arm 19 is transported until its center aligns with the center of the turntable 15 as shown in FIG. 11B. At this point, the first and second positioning projections 19a and 19b of the loading arm 19 cooperate, reliably aligning the center of the 8-cm optical disc with the center of the turntable 15.

As shown in FIG. 11A, the 8-cm optical disc is guided into the optical disc apparatus 1, while contacting the first and second positioning projections 19a and 19b of the loading arm 19 and being positioned near the first and second disc guides 23 and 25 and near the fulcrums 23a and 25a thereof. As a cam slider 31 is driven by a loading motor (not shown), the optical disc is further transported deeper into the optical disc drive 1 by the disc holding pin 27a of the disc holding lever 27.

As the cam slider 31 further slides, the engagement projection CO of the connection lever 21 enters an LO cam POS (8LO). Then, the first and second positioning projections 19a and 19b of the loading arm 19 are moved, guiding the optical disc until the center of the disc aligns with the center of the turntable 15 (or the shaft of the disc motor 13). At the same time, the engagement projection HO of the disc holding lever 27 enters the HO cam POS (8LO). Then, the disc holding pin 27a moves, pushing the optical disc until the center of the disc aligns with the center of the turntable 15 (or the shaft of the disc motor 13). The optical disc is thereby set at a prescribed position on the turntable 15, where it should be clamped. Since the disc has a diameter of 8 cm, the cam slider 31 does not move as much as in the case of inserting a 12-cm disc.

In order to rotate the 8-cm optical disc, the spring-force releasing mechanism (not shown) releases the disc holding lever 27 and the loading arm 19 from the tension that biases them toward the turntable 15. Thus, the loading arm 19 and the disc holding lever 27 are inhibited from contacting the outer circumference of the 12-cm optical disc.

As described above, a ring-shaped member having a diameter slightly larger than the outside diameter of the disc motor is arranged in a dead space near the motor. Thus, a clamping mechanism can be provided that saves space and can reliably clamp (chuck) an optical disc. That is, in the optical disc apparatus, the cam slider for controlling the loading and ejecting of an optical disc cooperates with the clamp lever and clamping ring, both moving in the cam groove made in the cam slider, to rotate the disc motor around the shaft thereof. The disc motor is therefore reliably moved to the standby position, so that an optical disc may be loaded or ejected. Hence, a simple structure can move the disc motor up and down, thereby chucking an optical disc and releasing the disc from a chucked state.

The three cams (provided in an odd number) formed on the ring-shaped member that rotates the disc motor are changed in terms of phase. The disc motor can therefore be inclined by a prescribed angle to a normal to the chassis (i.e., base member, or bottom cover) (or to a perpendicular to the center of the base member). In other words, the surface of the turntable can be inclined with respect to the surface of an optical disc moving to and from the turntable. Hence, the drive load for chucking and releasing an optical disc can be reduced. As a result, electrical power can be saved in chucking and releasing the optical disc. Further, since the disc motor can be parallel to the chassis (bottom cover) while it remains in the “down” position, not clamping any optical disc, a sufficient clearance is provided between the bottom of the motor and the chassis (bottom cover). Hence, the up-down stroke can be decreased, making it possible to render the optical disc apparatus thinner.

The three cam members for moving the disc motor up and down can be formed integrally as a single component. If they are so formed, the transmission loss will be smaller than in the case where a plurality of cam members are coupled to one another and then driven. In addition, the cam members can be positioned relative to one another with a high precision and can therefore serve to clamp an optical disc in a horizontal position (so that a laser beam may be applied at right angles to the optical disc). Therefore, the planar vibration the optical disc undergoes while data is being reproduced or read from or in it can be reduced, ensuring stable reproduction and recording of data.

As has been described, in a slot-in type optical disc apparatus according to an embodiment of this invention, the disc motor can be reliably moved to a standby position that does not interfere with an optical disc being inserted or ejected, and an optical disc can be clamped with a small pushing force.

Moreover, three cam members constituting a structure for moving the disc motor to the standby position are formed integrally as a single component. Hence, the transmission loss is smaller than in the case where a plurality of cam members are coupled to one another and then driven. Further, the structure can chuck an optical disc and can therefore reduce the planar vibration the optical disc undergoes while data is being reproduced or read from or in it.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc apparatus comprising:
a turntable which supports an optical disc and from which the optical disc is able to be removed from;
a disc motor which has a shaft coupled to the turntable and which is configured to rotate the turntable at a prescribed speed;
a ring member which has a diameter larger than an outer diameter of the disc motor and which is configured to rotate the disc motor;
a plurality of projections which are provided on an outer circumferential surface of the disc motor and which receive rotation from the ring member;
a plurality of slider members provided on the outer circumferential surface of the disc motor and which receive rotation from the ring member; and
a cam mechanism which linearly moves to rotate the ring member.

2. The apparatus according to claim 1, further comprising:
a cover member which pushes an optical disc onto the turntable.

3. The apparatus according to claim 1, further comprising:
a releasing member which releases an optical disc chucked, from the turntable.

4. The apparatus according to claim 1, wherein the ring member is an annular member which comprises a first flat part, a second flat part and a sloping part that are integrally formed with one another, the first flat part defining a normal position, the second flat part defining a disc-playback position, and the sloping part connecting the first and second parts.

5. The apparatus according to claim 4, wherein the ring member has projecting parts which are longer than a distance between the first flat part and the second flat part.

6. The apparatus according to claim 5, wherein the ring member has projecting parts which are longer than a distance between the first flat part and the second flat part and which pushes an optical disc onto the cover member.

7. The apparatus according to claim 5, wherein the first and second flat parts, sloping part and projecting parts of the ring member are arranged at substantially regular angular intervals of at least 90 degree.

8. The apparatus according to claim 6, wherein the first and second flat parts, sloping part and projecting parts of the ring member are arranged at substantially regular angular intervals of at least 90 degree.

9. The apparatus according to claim 7, wherein one of the projecting parts of the ring member differs in height from the other projecting parts.

10. The apparatus according to claim 8, wherein one of the projecting parts of the ring member differs in height from the other projecting parts.

11. The apparatus according to claim 1, wherein each of the slider members has a cam mechanism for converting a linear motion to rotation and a fulcrum for causing the cam mechanism to generate rotation.

12. An optical disc apparatus comprising:
a turntable which supports an optical disc and from which the optical disc is able to be removed from;
a disc motor which has a shaft coupled to the turntable and which is configured to rotate the turntable at a prescribed speed;
a base member which supports the disc motor, enabling the disc motor to rotate around the shaft of the disc motor;
a ring member which has a diameter larger than an outer diameter of the disc motor and which has a plurality of engagement members on the side that faces the disc motor, the engagement members being configured to engage with an outer circumferential surface of the disc motor to rotate the disc motor;
a plurality of engagement projections which are provided on the outer circumferential surface of the disc motor, and are arranged at substantially regular angular intervals of at least 90 degrees and receive a thrust from the engagement members of the ring member; and
a cam mechanism which linearly moves to rotate the ring member.

13. The apparatus according to claim 12, wherein when the engagement members of the ring member are rotated, the engagement members move along an axis extending at right angles to a direction in which the engagement members are rotated.

14. The apparatus according to claim 13, wherein at least one of the engagement members of the ring member differs in length from the other engagement members.

15. The apparatus according to claim 12, wherein the engagement members of the ring member are each an annular member comprising a first flat part, a second flat part and a sloping part that are integrally formed with one another, the first flat part defining a normal position, the second flat part defining a disc-playback position, and the sloping part connecting the first and second parts.

16. The apparatus according to claim 15, wherein the engagement members of the ring member have a projecting part which is longer than a distance between the first flat part and the second flat part.

17. The apparatus according to claim 16, wherein at least one of the engagement members of the ring member differs in length from the other engagement members.
